(19) United States
(12) Patent Application Publication
(10) Pub. No.: US 2026/0186194 A1
(43) Pub. Date: Jul. 2, 2026

(54) ASSEMBLY FOR ILLUMINATING A DECORATIVE MEMBER, AND MOTOR VEHICLE HAVING ASSEMBLY

(71) Applicant: MERCEDES-BENZ GROUP AG, Stuttgart (DE)

(72) Inventor: Marius SILLMANN, Böblingen (DE)

(21) Appl. No.: 19/123,855

(22) PCT Filed: Sep. 20, 2023
(86) PCT No.: PCT/EP2023/075956

§ 371 Date: Apr. 24, 2025

(30) Foreign Application Priority Data
Oct. 25, 2022 (DE) 10 2022 003 970.2

(51) Int. Cl. F21V 8/00; F21Y 115/10

(52) U.S. Cl. CPC G02B 6/0038; B60Q 1/28; B60R 13/005; F21S 43/245; G02B 6/0068; F21W 2104/00; F21Y 2115/10

(57) ABSTRACT

An assembly for illuminating a decorative member includes the decorative member and a light guide. The decorative member has a cavity, open at a back side and extending in the direction of a front side, which tapers in the direction of the front side and opens into at least one corresponding light emission aperture at the front side. A light-scattering body is accommodated in the cavity.

### BACKGROUND AND SUMMARY OF THE INVENTION

Exemplary embodiments of the present invention relate to an assembly for illuminating a decorative member, in particular for a motor vehicle, which comprises the decorative member and a light guide. The invention also relates to a motor vehicle having such an assembly.

It is known to illuminate decorative members in a motor vehicle.

For example, arranging a light source behind a decorative member is known from DE 10 2017 214 943 A1. On the side of the decorative member facing towards the light source, a laser is used to create a three-dimensional image that is lit up by the light source during operation.

Exemplary embodiments of the present invention are directed to an improved or at least other embodiments for an assembly, comprising a decorative member of the type mentioned above, for illuminating the decorative member and for a motor vehicle having such an assembly, which embodiments in particular overcome the disadvantages of the prior art. In particular, exemplary embodiments of the present invention are concerned with improved or at least other embodiments for the assembly and for the motor vehicle, which are characterized by a space-efficient design with an improved appearance.

The present invention is therefore based on the general idea of providing a decorative member to be illuminated, on the side facing away from the light-emitting side, with a cavity tapering towards the light-emitting side and into which a light-scattering material penetrates, the light emitted via the light-emitting side reaching the material by means of a light guide. The light-scattering material and the taper towards the light-emitting side ensure uniform illumination and targeted light guidance, while the cavity and the light guide also result in a compact design. As a result, the structure is compact and the appearance perceptible from the light-emitting side is improved.

In accordance with the idea of the invention, an assembly comprising the decorative member also has the light guide. The decorative member has a front side and a back side facing away from the front side. The light guide is arranged on the back side of the decorative member and extends along the back side. The decorative member has at least one cavity, open at the back side and extending in the direction of the front side, which tapers in the direction of the front side and opens into at least one corresponding light emission aperture at the front side. A light-scattering body is accommodated in the cavity, so that light introduced into the light guide radiates out from the at least one corresponding light emission aperture via the body. In the process, the at least one light emission aperture forms a pattern on the front side.

The pattern is thus illuminated during operation, i.e., when light is introduced into the light guide.

The light guide is preferably light-scattering. This provides homogeneous light guidance inside the light guide and consequently an improved appearance of the illuminated pattern.

Preferably, the light guide, facing away from the front side, is provided with a light coupling-out structure having structural elements in such a way that light guided through the light guide radiates from the structure in the direction of the at least one body. This provides improved light guidance inside the assembly and an improved appearance of the illuminated pattern.

The structure may be of any type.

The structure can have microstructures introduced at least partially into the light guide, for example. The microstructures can be introduced into the light guide by means of corresponding tools and/or by means of a laser.

The structure can have color elements, preferably white color elements, at least partially applied to a back side of the light guide facing away from the at least one body. The color elements can be applied to the back side in particular by means of color printing.

The decorative member may be a chrome frame, in particular. The chrome frame is advantageously a plastic component chrome-plated at least on the front side.

The front side of the decorative member forms the light emission aperture of the decorative member.

The front side of the decorative member is expediently visible in a corresponding application, in particular it is a visible surface, so that the illuminated pattern can be visible from the outside. Similarly, the pattern can be visible from the outside, outside of operation, i.e., when no light is being introduced into the light guide.

The assembly can be used in any application.

In particular, the assembly is used in a motor vehicle. Thus, the decorative member may be a decorative member of a motor vehicle. The decorative member can be a component of a radiator grille or a fitting of the motor vehicle or may form these.

If the decorative member has two or more such cavities, these are advantageously spaced apart from each other.

Advantageously, at least one of the at least one bodies tapers towards the at least one corresponding light emission aperture. Preferably, the body fills the corresponding cavity, at least substantially.

At least one of the at least one bodies can be a component of the light guide. This means that the light guide has the body as a projection and penetrates into the corresponding cavity with the body. This provides improved light guidance up to the at least one corresponding light emission aperture. Additionally, in this manner, mounting the assembly is simplified.

In particular, it is possible that the respective at least one body is a component of the light guide. If two or more such bodies are provided, the light guide therefore has two or more such projections which are advantageously spaced from each other.

At least one of the at least one light emission apertures can be covered with a foil, in particular a hot stamping foil, so that the corresponding body is invisible outside of operation. This leads to an improved appearance.

The foil, in particular the hot stamping foil, can for example be one which is known from DE 10 2014 112 073 A1.

The foil, in particular the hot stamping foil, can be applied on the front side of the decorative member. Similarly, it is possible to apply the foil, in particular the hot stamping foil, on the side of the body facing towards the at least one light emission aperture.

At least one of the at least one bodies can be a component of the decorative member, which is a multi-component part for this purpose, in particular a two-component part. In this case, the body is formed by a light-scattering component of the decorative member, also referred to as a scatter component in the following. In contrast, the corresponding cavity is delimited by another component of the decorative member, which expediently is not light-scattering, is preferably opaque, and is also referred to as a main component in the following. This leads to simplified mounting of the assembly. Additionally, this has the consequence that the pattern appears opaque from the outside, outside of operation, so that the appearance is improved.

Advantageously, the scatter component is a thermoplastic, preferably a polycarbonate or “PC” for short.

Advantageously, at least one of the at least one scatter components has a component inner side facing towards the light guide and the light guide has a guide outer side corresponding to the scatter component and facing towards the scatter component, which sides extend parallel, in particular also in planar fashion. This provides improved light transmission by the light guide into the scatter component and thus into the body. Consequently, in this manner the appearance is improved.

It is possible that at least one of the at least one cavities opens into a single such light emission aperture. This means that the light guided by means of the corresponding body radiates onto a single light emission aperture.

Similarly, it is conceivable that at least one of the at least one cavities opens into at least two, preferably more, such light emission apertures, which are recessed on the front side of the decorative member. This therefore provides an additional visual effect in the appearance, in particular in the appearance of the illuminated pattern.

The light emission apertures can be recessed on the front side in any manner.

In a simplified and precise manner, the light emission apertures can be made in the decorative member with a laser, i.e., using a laser process.

In principle, it is possible that at least one of the at least one bodies penetrates into at least one of the at least one corresponding light emission apertures.

In an advantageous embodiment, at least one of the at least one bodies, preferably the respective body, is spaced apart from the front side, in particular from the at least one corresponding light emission aperture. As a result, the body is not recognizable from the outside, or at least is more difficult to recognize, which leads to an improved appearance. Furthermore, in this manner environmental influences on the body are prevented or at least reduced, which provides improved resistance of the assembly.

The pattern formed by means of the at least one light emission aperture can be of any type.

In particular, the pattern may be a logotype. Similarly, the pattern may be a logo.

Preferred embodiments are those in which a surface density of the structural elements of the structure increases towards the center of the pattern. This means that towards the center of the pattern, the share of the surface area occupied by the structural elements increases. This leads to a homogenization of the illuminated pattern and consequently to an improved appearance. Alternatively or additionally, the structural elements can be more pronounced towards the center of the pattern for this purpose.

In preferred embodiments, the light for illuminating the pattern is introduced along the front side and/or along the back side into the light guide. This therefore provides a compact design of the assembly and an improved appearance.

The light is introduced by means of at least one light source, which creates and outputs light during operation.

Advantageously, at least one of the at least one light sources, preferably the respective light source, may be an LED. This provides a more compact design and economical operation.

At least one of the at least one light sources can be a component of the assembly and light can be introduced into the light guide along the back side or the front side during operation.

The at least one body and/or the light guide is/are expediently fixed relative to the decorative member. For this purpose, the at least one body and/or the light guide can be adhesively bonded to the decorative member. This can take place by applying at least one adhesive tape, for example.

Advantageously, the light guide, in particular together with the at least one light source, preferably also together with a corresponding electronics unit, is accommodated in a housing part.

The housing part is preferably arranged on the back side of the decorative member and is connected fluidically sealed to the back side. Thus, the components accommodated in the housing part, i.e., the light guide, preferably also the at least one light source, preferably also the electronics unit, are protected from external influences, in particular from an ingress of fluids. The fluidically sealed connection can, for example, be achieved by means of a potting compound.

It is understood that in addition to the assembly, the motor vehicle with the assembly also forms part of the scope of the present invention.

Further important features and advantages of the invention result from the dependent claims, the drawings and the associated figure description with reference to the drawings.

It is understood that the aforementioned features and the features still to be explained in the following can not only be used in the respectively specified combination, but also in other combinations or in isolation, without leaving the scope of the pre-sent invention.

Preferred exemplary embodiments of the invention are represented in the drawings and are explained in more detail in the following description, wherein the same reference numerals refer to identical or similar or functionally identical components.

### BRIEF DESCRIPTION OF THE DRAWING FIGURES

In the figures:

FIG. 1 schematically shows a section through an assembly having a decorative member in a motor vehicle,

FIG. 2 schematically shows an isometric external view of the assembly in the motor vehicle in an illuminated state,

FIG. 3 schematically shows the view from FIG. 2 in an unilluminated state,

FIG. 4 schematically shows a section through an assembly in another exemplary embodiment,

FIG. 5 schematically shows a section through an assembly in a further exemplary embodiment,

FIG. 6 schematically shows an internal view of the assembly.

### DETAILED DESCRIPTION

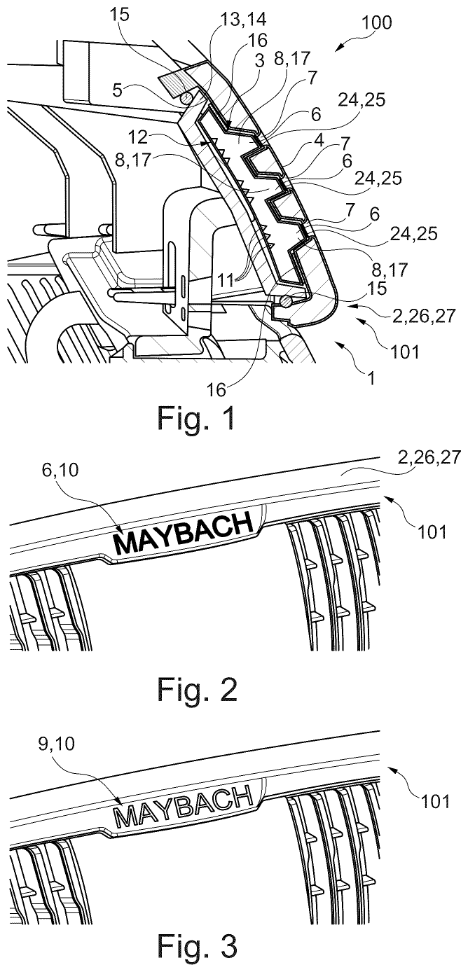

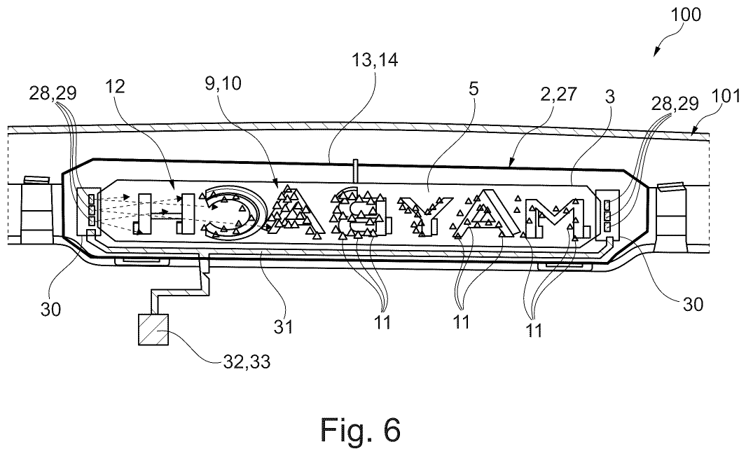

An assembly 1 for illuminating a decorative member 2, as is shown in FIGS. 1 to 6, for example, can be used in a motor vehicle 100 shown by way of example in FIGS. 1 to 6. The assembly 1 comprises a light guide 3, in addition to the decorative member 2. The light guide 3 is in the exemplary embodiments shown and preferably light-scattering. The decorative member 2 has a front side 4 and a back side 5 facing away from the front side 4. The light guide 3 is arranged on the back side 5 of the decorative member 2 and extends along the back side 5. The decorative member 2 has at least one cavity 6, open at the back side 5 and extending in the direction of the front side 4, which tapers in the direction of the front side 4. Additionally, the cavity 6 opens into at least one corresponding light emission aperture 7 at the front side 4. A body 8, which is light-scattering, is accommodated in the at least one cavity 6, so that light introduced into the light guide 3 (see FIG. 6) radiates via the body 8 out from the at least one corresponding light emission aperture 7. The at least one light emission aperture 7 thus forms a pattern 9 on the front side 4, as can be seen in particular from FIGS. 2 and 3. Consequently, the pattern 9 is illuminated during operation, i.e., when light is introduced into the light guide 3. FIG. 2 shows the illuminated state, whereas FIG. 3 shows an unilluminated state and thus a state outside of operation.

In the exemplary embodiments shown, the decorative member 2 is a chrome frame 26, which is a chrome-plated plastic component 27. In this case, the decorative member 2 can be a component of a radiator grille 101 of the motor vehicle 100.

As can be seen from FIGS. 2 and 3, the pattern 9 forms a logotype 10 in the exemplary embodiments shown. As can also be seen from FIGS. 2 and 3, the decorative member 2 has two or more such cavities 6 and the assembly 1 for the respective cavity 6 has a corresponding such body 8. It can furthermore be seen from an overview of FIGS. 1 to 3 that, in the exemplary embodiments shown, purely by way of example, a cavity 6 is assigned to the respective letters of the logotype 10. In particular, the respective letter is formed by the at least one corresponding light emission aperture 7.

As can be seen from FIGS. 1, 4, and 5, in the exemplary embodiments shown, the respective body 8 tapers analogous to the corresponding cavity 6 in the direction of the front side 4. As can additionally be seen from the figures, in the exemplary embodiments shown, the respective body 8 substantially fills the corresponding cavity 6.

As can be seen from FIGS. 1, 4, and 5, the light guide 3, facing away from the front side 4, is provided with a light coupling-out structure 12 having structural elements 11 in such a way that light guided through the light guide radiates from the structure 12 in the direction of the at least one body 8.

In the exemplary embodiment shown in FIG. 1, the respective body 8 is a component of the light guide 3 and is formed as a projection 17 of the light guide 3. Consequently, the light guide 3 for the respective cavity 6 has a corresponding projection 17 as a body 8, with which the light guide 3 penetrates into the corresponding cavity 6.

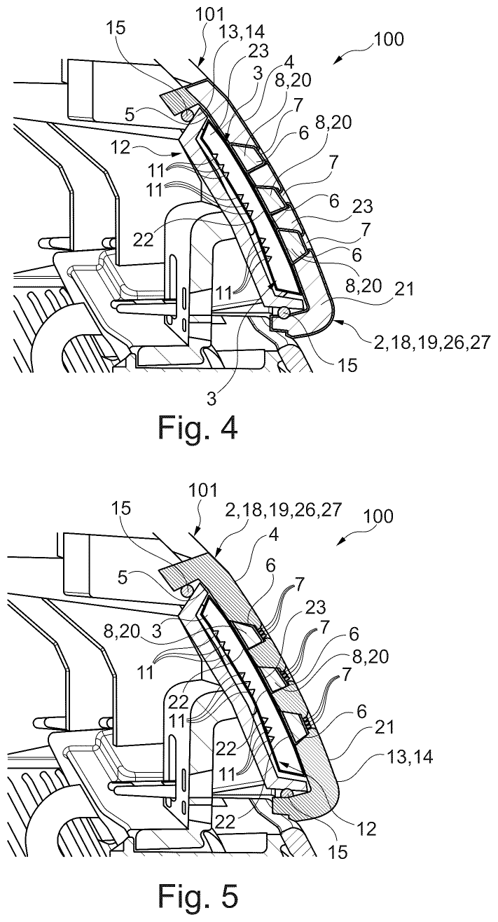

In the exemplary embodiments shown in FIGS. 4 and 5, the respective body 8 is a component of the decorative member 2. For this purpose, the decorative member 2 is designed as a multi-component part 18, in the exemplary embodiments shown as a two-component part 19. The respective body 8 is formed by a light-scattering component 20 of the decorative member 2, also referred to as a scatter component 20 in the following. The scatter component 20 may be polycarbonate, for example. In contrast, the respectively corresponding cavity is delimited by another component 21 of the decorative member 2, which is also referred to as a main component 21 in the following. The main component 21 is translucent in the exemplary embodiments shown. In the exemplary embodiments shown in FIGS. 4 and 5, the respective scatter component 20 has a component inner side 22 facing towards the light guide 3 and the light guide 3 has a guide outer side 23 corresponding to the scatter component 20 and facing towards the scatter component 20, which sides extend parallel and in a planar fashion.

As can be seen in FIGS. 1 and 4, the respective cavity 6 can open into a single such light emission aperture 7. As can be seen from FIG. 5, the respective cavity 6 can open into at least two, preferably more, light emission apertures 7, which are recessed on the front side 4 of the decorative member 2, for example by means of a laser method with a laser.

In the exemplary embodiments shown, the respective body 8 is spaced apart from the at least one corresponding light emission aperture 7 and thus from the front side 4.

As can be seen from FIG. 1, the light emission apertures 7 can be covered with a foil 24, in particular a hot stamping foil 25, so that the corresponding body 8 is invisible when there is no light emission from the light emission aperture 7. In the exemplary embodiment shown, the foil 24 is applied on the side of the respective body 8 facing towards the at least one corresponding light emission aperture 7.

As can be seen from FIG. 6, in the exemplary embodiments shown, a light source 28 for introducing light into the light guide 3 is a component of the assembly 1. The assembly 1 therefore has at least one such light source 28, which introduces light along the back side 5 and/or along the front side 4 into the light guide 3. The at least one light source 28 is an LED 29 in the exemplary embodiments shown. In the exemplary embodiments shown, the assembly 1 has at least two such light sources 28, each of which introduces light from the side into the light guide 3 during operation. As can be seen from FIG. 6, the light sources 28 are arranged to the side of the pattern 9 in the exemplary embodiment shown.

In the example shown in FIG. 6, purely by way of example, the assembly 1 has six such LEDs 29, wherein in each case three LEDs 29 are arranged opposite each other. Thus, during operation light is introduced from the side into the light guide 3 by means of the LEDs 29, as indicated with dashed arrows for only three of the LEDs 29. The opposite LEDs 29, i.e., in each case three LEDs 29 in the exemplary embodiments shown, are preferably applied on a circuit board 30 in the exemplary embodiment shown in FIG. 6. As can be seen from FIG. 6, a supply line 31 for supplying electricity to the light sources 28 leads to the respective circuit board 30.

As can also be seen from the figures, the assembly 1 in the exemplary embodiments shown has a housing part 14 designed as a shell 13, in which the light guide 3 is accommodated. The housing part 14 is arranged on the back side 5 of the decorative member 2, and fixed to the decorative member 2, so that the decorative member 2 closes the housing part 14 designed as a shell 13. Additionally, the shell 13 is sealed from the outside. In the exemplary embodiments shown, this takes place via a fluidically sealed connection of the housing part 14 to the decorative member 2. For this purpose, in the exemplary embodiments shown, a potting compound 15 is arranged between the decorative member 2 and the housing part 14. Thus, the components accommodated in the housing part, i.e., in particular the light guide 3, preferably also the at least one light source 28, preferably also the electronics unit, are protected from external influences, in particular from an ingress of fluids. The fluidically sealed connection can, for example, be achieved by means of a potting compound 15. As can be seen from FIG. 2, alternatively or additionally, it is also possible to adhesively bond the light guide 2, for example with at least one adhesive tape 16, to the back side 5 to the back side 5.

The supply line 31 has an interface 32 outside the housing part 14 according to FIG. 6 in the exemplary embodiment shown, for example a plug 33, with which the supply line 31 can be connected to a vehicle electrical system (not shown) of the motor vehicle 100.

Similarly, the light sources 28 together with the circuit board 30 are accommodated in the housing part 14 in the exemplary embodiment shown. FIG. 6 shows an internal view in the direction of the back side 5, in which the housing part 14 is represented only at the edge for improved understanding.

As can be seen from FIG. 6, the number of structural elements 11 increases towards the center of the pattern 9 in the exemplary embodiment shown. This means that a surface density of the structural elements 11 increases towards the center of the pattern 9. As indicated in FIG. 6 with differently sized structural elements 11, the structural elements 11 are also more pronounced towards the center of the pattern 9.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. An assembly comprising:
a decorative member having a front side and a back side facing away from the front side;
a light guide arranged on the back side of the decorative member and extending along the back side of the decorative member, wherein the decorative member has at least one cavity, open at the back side of the decorative member and extending in a direction of the front side, wherein the at least one cavity tapers in the direction of the front side and opens into at least one corresponding light emission aperture at the front side of the decorative member; and
a light-scattering body accommodated in the at least one cavity so that light introduced into the light guide radiates out from the at least one corresponding light emission aperture via the respective light-scattering body,
wherein the at least one light emission aperture forms a pattern on the front side of the decorative member.

12. The assembly of claim 11, wherein at least one of the at least one respective light-scattering bodies is a component of the light guide so that the light guide penetrates into the corresponding at least one cavity.

13. The assembly of claim 11, wherein the decorative member is a multi-component part and at least one of the at least one light-scattering body is formed by a light-scattering scatter component of the decorative member and the corresponding cavity is delimited by a main component of the decorative member.

14. The assembly of claim 13, wherein at least one of the at least one scatter component has a component inner side facing towards the light guide and the light guide has a guide outer side corresponding to the respective at least one scatter component and facing towards the respective at least one scatter component, and has sides extending in a parallel and planar manner.

15. The assembly of claim 11, wherein at least one of the at least one light emission aperture is covered with a foil so that the corresponding body is invisible when there is no light emission from the at least one of the light emission aperture.

16. The assembly of claim 11, wherein at least one of the at least one cavity opens into a single one of the at least one light emission aperture.

17. The assembly of claim 11, wherein at least one of the at least one cavities opens into at least two light emission apertures, which are recessed on the front side of the decorative member.

18. The assembly of claim 11, wherein at least one of the at least one light-scattering body is spaced apart from the front side of the decorative member.

19. The assembly of claim 11, wherein
the light guide, facing away from the front side of the decorative member, includes a light coupling-out structure having structural elements configured in such a way that light introduced into the light guide radiates from the light coupling-out structure in a direction of the at least one body, and
a surface density of the structural elements increases towards a center of a pattern of the structural elements.

20. The assembly of claim 11, wherein the assembly forms a radiator grill of a motor vehicle.

21. A motor vehicle comprising:
an assembly comprising
a decorative member having a front side and a back side facing away from the front side;
a light guide arranged on the back side of the decorative member and extending along the back side of the decorative member, wherein the decorative member has at least one cavity, open at the back side of the decorative member and extending in a direction of the front side, wherein the at least one cavity tapers in the direction of the front side and opens into at least one corresponding light emission aperture at the front side of the decorative member; and
a light-scattering body accommodated in the at least one cavity so that light introduced into the light guide radiates out from the at least one corresponding light emission aperture via the respective light-scattering body,
wherein the at least one light emission aperture forms a pattern on the front side of the decorative member.

22. The motor vehicle of claim 21, wherein the assembly forms a radiator grill of the motor vehicle.
